(19) United States
(12) Patent Application Publication
(10) Pub. No.: US 2018/0310149 A1
(43) Pub. Date: Oct. 25, 2018

(54) CLOUD MANAGEMENT SYSTEMS AND DEVICE CONFIGURATION METHODS THEREOF

(71) Applicant: Acer Incorporated, New Taipei City (TW)

(72) Inventors: Chia-Hsun LEE, New Taipei City (TW); Chao-Kuang YANG, New Taipei City (TW); Cheng-Kang CHAO, New Taipei City (TW); Cheng-Hung CHEN, New Taipei City (TW); Chi-Hung CHANG, New Taipei City (TW)

(21) Appl. No.: 15/955,930

(22) Filed: Apr. 18, 2018

(30) Foreign Application Priority Data
Apr. 24, 2017 (TW) 106113589

(51) Int. Cl. H04W 4/50; H04W 88/18; H04W 88/16; H04W 76/10; H04W 4/12

(52) U.S. Cl. CPC H04W 4/50; H04W 88/18; H04L 65/102; H04W 76/10; H04W 4/12; H04W 88/16

(57) ABSTRACT

A device configuration method for use in a cloud system including a gateway device, a mobile device and a cloud server is provided. The method includes the steps of: establishing a connection between the mobile device and the gateway device through the cloud server; sending, by the gateway device, a notification message to the mobile device through the established connection when detecting that a first device is connected to a connection port; and in response to receiving the notification message, identifying, by the mobile device, the first device according to a first identification information within the notification message and displaying a user interface displaying at least one application corresponding to the first device, obtaining one or more servers corresponding to the at least one application via the user interface and transmitting the obtained services to the gateway device to be configured and performed thereon.

### CROSS REFERENCE TO RELATED APPLICATIONS

100011 This Application claims priority of Taiwan Application No. 106113589, filed on Apr. 24, 2017, and the entirety of which is incorporated by reference herein.

### BACKGROUND OF THE INVENTION

### Field of the Invention

The invention generally relates to cloud management technology, and more particularly, to cloud management systems and device configuration methods thereof capable of providing remote configuration of a gateway device.

### Description of the Related Art

In recent years, portable devices, such as mobile or handheld devices, have become more and more advanced technology and having versatility. For example, the mobile device can receive e-mail messages, phone book has an advanced management application that allows multimedia playback, and has a variety of other functions. As these devices have the convenience versatile, making these devices indispensable in life.

In addition, with the rapid progress of science and technology and the Internet, information technology has grown rapidly, leading to a greater emphasis on Internet of Things (IoT) development and cloud computing. IoT which can constitute a Thing-to-Thing interconnected Internet is an important development line for the current industry and a gateway device (also referred to as IoT gateway) can be utilized to establish network communication channels among different IoT devices. Generally, the gateway device is preloaded with a set of required services at the time of shipment and these services can be applied to particular IoT devices. With the rapid development of IoT devices and applications, the gateway device may need to regularly update or modify contents of the services preloaded or configured thereon in order to support new IoT devices and applications. Currently, the gateway device can only be updated through an online updating process when services of the gateway device are required to be added or modified in order to support a variety of IoT devices. During the updating process, however, the gateway device will be nonfunctional and requires long time for the updating, so that it can't be updated easily and frequently, affecting the scalability of the gateway functionality. In addition, as services are usually provided by the official, contents of these services can't be customized to provide desired functionalities.

Therefore, the need exists for management systems and methods thereof for IoT applications that can easily configure services of the gateway device.

### BRIEF SUMMARY OF THE INVENTION

Cloud management systems and device configuration methods thereof are provided.

An embodiment of the invention provides a device configuration method for use in a cloud system including a gateway device, a mobile device and a cloud server is provided. The method includes the steps of: establishing a connection between the mobile device and the gateway device through the cloud server; sending, by the gateway device, a notification message to the mobile device through the established connection when detecting that a first device is connected to a connection port, wherein the notification message includes first identification information corresponding to the first device; identifying, by the mobile device, the first device according to first identification information within the notification message and displaying a user interface, wherein the user interface displays at least one application corresponding to the first device in response to receiving the notification message; obtaining, by the mobile device, one or more services corresponding to the at least one application via the user interface; and transmitting, by the mobile device, the obtained one or more services to the gateway device through the established connection to configure the one or more services on the gateway device such that the gateway device automatically performs the one or more services, thereby controlling the operation of the first device.

Another embodiment of the present invention provides a cloud management system comprising at least one first device, a gateway device, a mobile device and a cloud server. The first device has a connection port. The gateway device has a connection port. The cloud server is coupled to the gateway device and the mobile device via a communication network. The mobile device and the gateway device establishes a connection through the cloud server, and the gateway device sends a notification message to the mobile device through the established connection when detecting that the connection port is connected to the connection port of the first device such that the mobile device, in response to receiving the notification message, identifies the first device according to the notification message and displays a user interface which displays at least one application corresponding to the first device, obtains one or more services corresponding to the at least one application via the user interface, and transmits the obtained one or more services to the gateway device through the established connection to configure the one or more services on the gateway device such that the gateway device automatically performs the one or more services, thereby controlling the operation of the first device.

Methods may be practiced by the disclosed apparatuses or systems which are suitable firmware or hardware components capable of performing specific functions. Methods may also take the form of a program code embodied in a tangible media. When the program code is loaded into and executed by an electronic device, a processor, a computer or a machine, the electronic device, the processor, the computer or the machine becomes an apparatus for practicing the disclosed method.

### BRIEF DESCRIPTION OF DRAWINGS

The invention can be more fully understood by reading the subsequent detailed description and examples with references made to the accompanying drawings, wherein:

FIG. 1 is a schematic diagram illustrating an embodiment of a cloud management system of the invention;

FIGS. 2A and 2B are schematic diagrams illustrating some embodiments of user interfaces of the invention;

FIG. 3 is a flowchart of an embodiment of a device configuration method of the invention;

FIG. 4 is a flowchart of another embodiment of a device configuration method of the invention; and

FIG. 5 is a flowchart of an embodiment of a device configuration application of the invention.

### DETAILED DESCRIPTION OF THE INVENTION

The following description is of the best-contemplated mode of carrying out the invention. This description is made for the purpose of illustrating the general principles of the invention and should not be taken in a limiting sense. It should be understood that the embodiments may be realized in software, hardware, firmware, or any combination thereof.

Embodiments of the invention provide cloud management systems and related device configuration methods, which can be perform gateway device configuration and management for a gateway device through the cloud, and when one external device is connected to a connection port of the gateway device, a message containing information related to inserted device can be automatically sent to a mobile device as notification to drive the gateway device to install required services by the third party so that the user can freely determine the functionalities of the gateway device according to the different hardware devices, to improve the scalability of the gateway device in a more intelligent and convenient manner so as to easily update the gateway device for supporting a variety of new external devices.

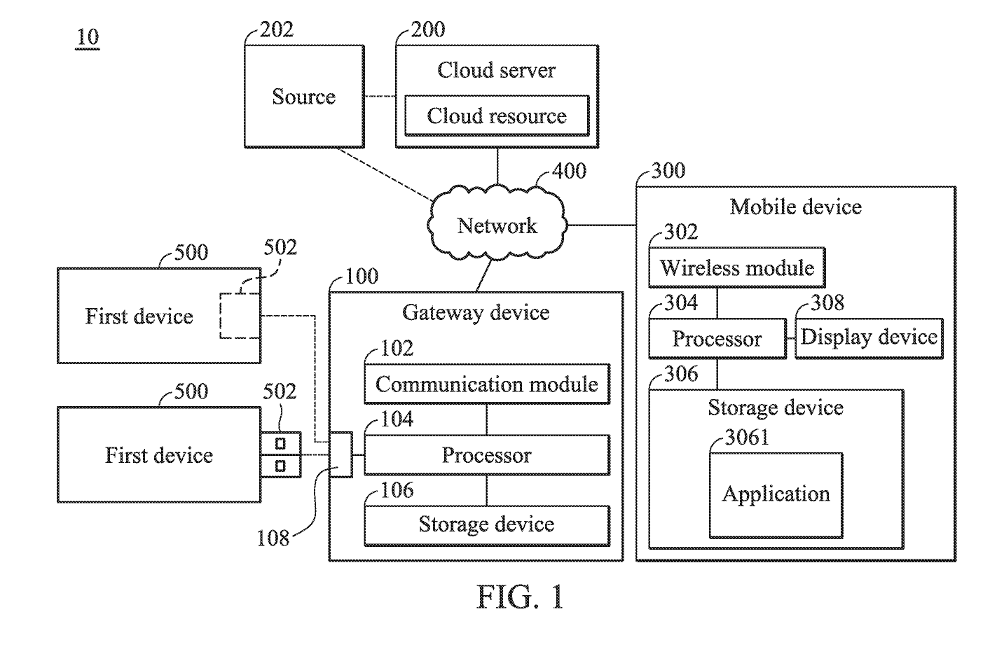

FIG. 1 is a block diagram of a cloud management system in accordance with an exemplary embodiment of the invention. As shown in FIG. 1, the cloud management system 10 may comprise a gateway device 100, a cloud server 200 and one or more mobile devices 300, wherein the gateway device 100 is capable of communicating with the mobile devices 300 through the cloud server 200. To be more specific, the gateway device 100 and the mobile devices 300 may be coupled to the cloud server 200 via a connected communication network 400 (e.g., any wired/wireless communication networks, such as the Internet, 3G, and/or WLAN network, etc. . . . ). The gateway device 100 and the mobile devices 300 may further communicate with the cloud server 200 via the connected communication network 400. In some embodiments, the mobile device 300 can be a portable device or a handheld device, such as a PDA, a smartphone, a mobile phone, a tablet, an Mobile internet device (MID), a laptop computer, a car computer, a digital camera, a multimedia player or a game device, or any other type of mobile computational device, however, it is to be understood that the invention is not limited thereto.

The gateway device 100 at least comprises a communication module 102, a processor 104 and a storage device 106. The communication module 102 receives signals from and transmits signals to a current associated network. The communication module 102 may further comprise a wireless module (not shown), which can be coupled to one or more antennas (not shown) and may allow communications with one or more additional devices, computers and/or servers using a wireless network. The communication module 102 may support various communications protocols, such as the code division multiple access (CDMA), Global System for Mobile Communications (GSM), Enhanced Data GSM Environment (EDGE), High-Speed Downlink Packet Access (HSDPA), Wi-Fi (such as IEEE 802.11a/b/g/n), Bluetooth, and Wi-MAX communication protocol, and a protocol for emails, instant messaging (IM), and/or a short message services (SMS), but the invention is not limited thereto. The processor 104 may be a microprocessor which is capable of executing one or more types of computer readable medium stored in the storage device 106 such as a memory. The storage device 106 may be a memory of the gateway device 100 and also may be an external storage card, such as a smart media (SM) card or secure digital (SD) card, for example. Application codes (not shown) stored in the storage device 106 are executed by the processor 104 to control the communication module 102 and the storage device 106 to perform the device configuration method of the invention. For example, the storage device 106 may store program codes of operating systems such as Linux operating system, Windows operating system or other similar operating system and the program codes of operating systems stored in the storage device 106 can be loaded and executed by the processor 104 to run the operating systems. In other words, the gateway device 100 may be considered as a small-scale computing means having the ability to operate a specific operating system independently.

The processor 104 which is coupled to the communication module 102 and the storage device 106 can control the communication module 102 and the storage device 106 to perform the device configuration method of the present invention, which will be discussed further in the following paragraphs.

The gateway device 100 may further include one or more connection ports 108, which can be used to connect or insert one or more first devices 500 in a wired or wireless manner. For example, the connection port 108 can be any common input or output ports, such as a universal serial bus (USB) port or a high-definition multimedia interface (HDMI) port, etc., which can be connected with the first device 500 through physical wired connection. In addition to the physical wired connections, the connection port 108 may also include a wireless connection port which can be provided with wireless connectivity that allows the external first device 500 to connect it in a wireless manner such as via wireless LAN or Bluetooth network or other wireless connections, but the invention is not limited thereto.

In some embodiments, the first device 500 may be a variety of hardware components, such as a camera, a 3D printer, a remote control vehicle, a lamp, a light emitting diode (LED), a dedicated development board, and the like, but the invention is not limited thereto. In this embodiment, the first device 500 may be considered as a device to be configured, which can be configured and controlled via the gateway device 100, and when those devices are connected to the gateway device 100 through the port 108, they can be referred to as IoT devices and the operations to be performed for the IoT devices can be determined by the services configured on the gateway device 100.

In some embodiments, the first device 500 may be a variety of sensors or detectors, wherein said sensor/detector can be used to collect or measure a variety of sensor data, such as various sensing data related to the environment such as temperature, humidity and so on.

The gateway device 100 may provide device information of the first device 500 to the cloud server 200. For example, in one embodiment, device information of the first device 500 may include device-related information, such as a device code or function code and the installation information, and so on.

The mobile device 300 may further comprise a wireless module 302, a processor 304, a storage device 306 and a display device 308. The wireless module 302 receives signals from and transmits signals to a current associated network. It is to be understood that integrating the processor 304 into the wireless module 302 is also possible. The wireless module 302 may be coupled to one or more antennas (not shown) and may allow communications with one or more additional devices, computers and/or servers using a wireless network. The mobile device may support various communications protocols, such as the code division multiple access (CDMA), Global System for Mobile Communications (GSM), Enhanced Data GSM Environment (EDGE), High-Speed Downlink Packet Access (HSDPA), Wi-Fi (such as IEEE 802.11a/b/g/n), Bluetooth, and Wi-MAX communication protocol, and a protocol for emails, instant messaging (IM), and/or a short message services (SMS), but the invention is not limited thereto. The processor 304 may be one or more data processors, image processors and/or central processors, which are capable of executing one or more types of computer readable medium stored in the storage device 306 such as a memory.

The storage device 306 may be a memory of the mobile device 300 and also may be an external storage card, such as a smart media (SM) card or secure digital (SD) card, for example. The application codes 3061 stored in the storage device 306 are executed by the processor 304 to display application and respective user interface on the display device 308 (e.g. a touch panel) for the user to configure the gateway device 100 using the application and respective user interface. The storage device 306 may further include an application corresponding to the gateway device 100 for communication with the gateway device 100. The processor 304 may obtain the application corresponding to the gateway device 100 from a source 202. The application may provide a user interface 3062, and the processor 304 may interact with the user via the user interface 3062 to obtain various user selections.

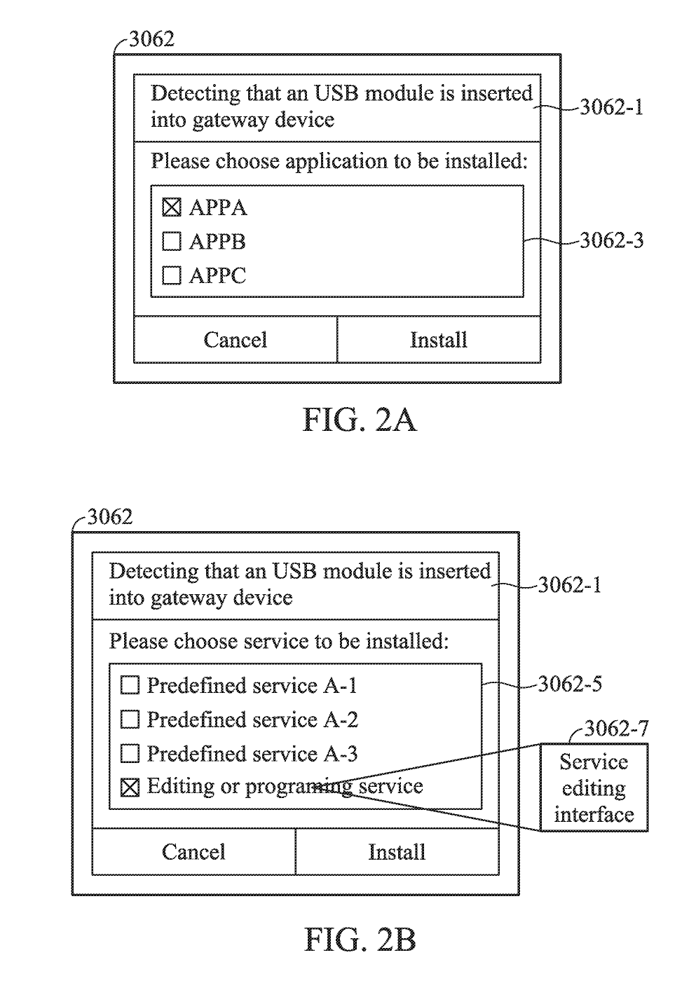

Refer to FIGS. 2A and 2B. FIGS. 2A and 2B are schematic diagrams illustrating some embodiments of user interfaces of the invention. As shown in FIG. 2A, the user interface 3062 at least includes a plurality of display areas 3062-1 and 3062-3, wherein the display area 3062-1 displays the relevant information of the first device 500 detected by the gateway device 100 and the display area 3062-3 displays an installable application menu corresponding to the first device 500. For example, the display area 3062-1 displays the contents of “Detecting that an USB module is inserted into gateway device” indicating that the first device 500 is connected to a USB port of the gateway device, and the display area 3062-3 displays the contents of “APPA”, “APPB”, and “APPC” indicating that there are application options of APPA, APPB, and APPC that can be selected to be installed into the first device 500. Among them, each of the application options displayed in the display area 3062-3 may additionally provide a selection key or button (e.g., a checkbox) for the user to input a selection of the application option to be installed. The user interface 3062 may further provide a confirmation button, such as an “Install” or “Cancel” button, allowing the user to install the selected application option via the “Install” button or cancel the installation via the “Cancel” button. As shown in FIG. 2A, the checkbox of the application option “APPA” is being checked or selected to indicate that the user wants to install the application APPA for the first device 500. When the user installs the selected application APPA by the “Install” button, the application APPA is installed on the mobile device 300, wherein the application APPA may have one or more corresponding service options and the user interface 3062 switches the display content to display the one or more service options corresponding to the app APPA for selection by the user. As shown in FIG. 2B, the display of the user interface 3062 is switched to the display area 3062-5, wherein the display area 3062-5 displays a plurality of service options corresponding to the selected application APPA, which are “Predefined service A-1”, “Predefined service A-2”, and “Predefined service A-3”, respectively.

The contents of these predefined services may be provided by the developer of the first device 500 or may be obtained from the source 202. The source 202 may include at least applications corresponding to the gateway device 100, all the installable applications of the first device 500 and the corresponding one or more services and other resources. Specifically, the source 202 has applications (APPs) corresponding to the gateway device 100 and APPs corresponding to the first device 500. Each of the first devices 500 may have a plurality of corresponding APPs, and the APPs corresponding to the gateway device 100 displays a corresponding APP menu for the user to select, wherein each APP corresponds to a plurality of services. Each service is a program written for the first device 500, and as long as the gateway device 100 is activated, it will operate continuously, so that the operation of the first device 500 can be controlled by the service. For example, if the first device 500 is a camera, the corresponding services may be a variety of shooting modes, such as 24-hours of continuous recording, taking a picture every minute and then making a time-lapse photography or immediately streaming to the remote device after photographing, and so on, but the invention is not limited thereto. The mobile device 300 may directly connect to the source 202 through the network 400 to obtain the aforementioned resources or it may have to access the resources from the source server 202 through the cloud server 200 to obtain the aforementioned resources.

In some embodiments, the source 202 may be an App store, such as the Google PLAY store of the Android system or the Apple App store of the Apple system. In other embodiments, the source 202 may be a cloud storage space or a website storing all the corresponding services of the first device 500 to be configured, and the mobile device 300 may link to the cloud storage space or website to obtain the selected service for installation.

The display area 3062-5 may further provide an option of “Editing or programing service”, and the user interface 3062 switches to a service editing interface 3062-7 when the “Editing or programing service” option is being selected. Through the service editing interface 3062-7, the user can choose to use the predefined service A-1, A-2 or A-3 as a template for editing or directly write the service content to generate a new customized service. In one embodiment, the user may directly use the APP to edit a service. Detail of APP editing will be discussed further in the following embodiments.

The display device 308 is configured to display related data, such as texts, figures, use interfaces, and/or related information. It is understood that, in some embodiments, the display device 308 may be integrated with a touch-sensitive device (not shown). The touch-sensitive device has a touch-sensitive surface comprising sensors in at least one dimension to detect contact and movement of at least one object (an input tool), such as a pen/stylus or a finger near or on the touch-sensitive surface. Thus, users can input relevant commands or signals via the screen of the display device 308.

The processor 304 which is coupled to the wireless module 302, the storage device 306 and the display device 308 can control the wireless module 302, the storage device 306 and the display device 308 to perform the device configuration method of the present invention, which will be discussed further in the following paragraphs.

The cloud server 200 is coupled to the gateway device 100 and the mobile device 300 through the communication network 400 to perform the device configuration method of the present invention, so as to manage the access of the cloud resources of the gateway device 100 and the mobile device 300. Generally, cloud resources correspond to login information such as user account, wherein different login information correspond to different cloud resources, while the same login information can share the same cloud resources.

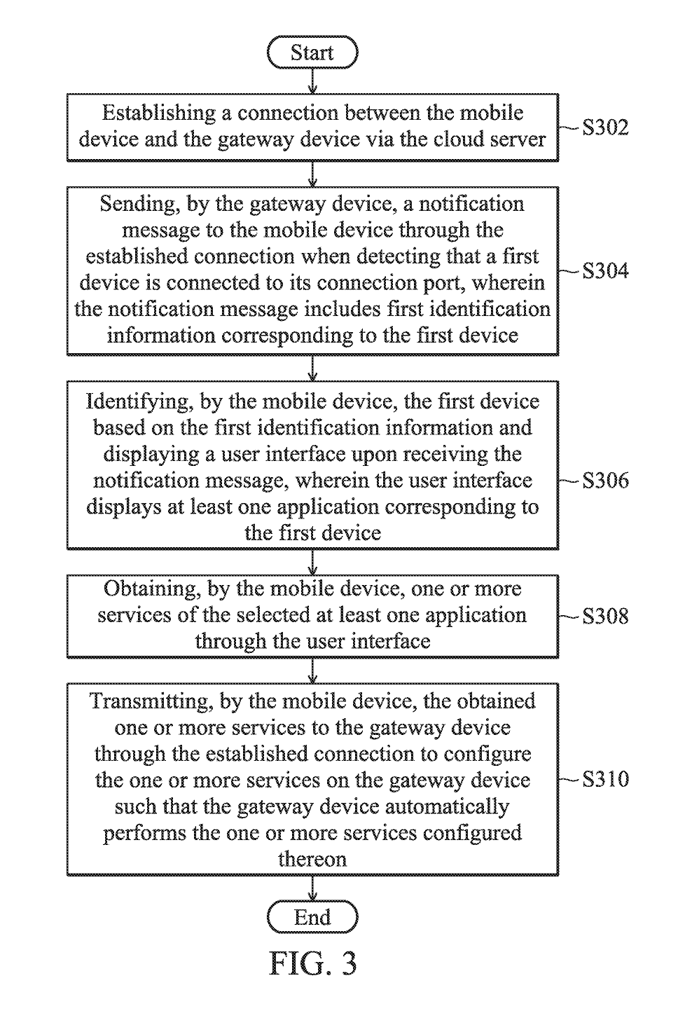

FIG. 3 is a flowchart of an embodiment of a device configuration method for providing remote functional configuration of a gateway device and management of device connected thereto in a communication network of the invention. The device configuration method can be applied to the cloud management system 10 as shown in FIG. 1. For example, the method can be performed by the processor 104 of the gateway device 100, the cloud server 200 and the processor 304 of the mobile device 300 as shown in FIG. 1.

First, in step S302, a connection between the mobile device 100 and the gateway device 300 is established via the cloud server 200. To be more specific, the mobile device 300 first downloads and installs the application corresponding to the gateway device 100 from the source 200, for example, the Apple App store, and the application corresponding to the gateway device 100 is connected to the network 400 and requests for logging a user account. The mobile device 300 logs in the application corresponding to the gateway device 100 with a designated user account such as a Google+ or a Facebook account. In this embodiment, the gateway device 100 may further include a connection port (e.g., the connection port 108). For example, the connection port 108 can be a wired port such as a universal serial bus (USB) port and a wireless port such as a WIFI port and a Bluetooth (BT) port, etc., but the invention is not limited thereto.

Thereafter, the application corresponding to the gateway device 100 is connected to the gateway device 100 through the Bluetooth (BT), and the Wi-Fi connection is set. After the setting is completed, the gateway device 100 will bind to the user account. The gateway device 100 and the mobile device 300 can then establish a network connection through the cloud server 200. In one embodiment, the gateway device 100 and the mobile device 300 each log in the cloud server 200 using the same login information. In some embodiments, the login information contains at least a login account and a password corresponding to the login account, wherein the login account corresponds to a specific cloud resource of the cloud server 200. In other words, as the gateway device 100 and the mobile device 300 use the same login account and password to log in the cloud server 200, both the gateway device 100 and the mobile device 300 share one particular cloud resource. Thereafter, the gateway device 100 and the mobile device 300 may communicate with each other through the established connection.

Subsequently, in step S304, the gateway device 100 sends a notification message to the mobile device 300 through the connection established at step S302 when detecting that a first device 500 is connected or inserted to its connection port (e.g., a USB port), wherein the notification message includes first identification information corresponding to the first device 500. Specifically, after the first device 500 has been connected to the gateway device 100 in a wired or wireless manner, the application (APP) corresponding to the gateway device 100 on the mobile device 300 may receive the aforementioned notification message. For example, the first device 500 may have a connection port 502 of a type as same as that of the connection port 108, which can be used to insert into the connection port 108 of the gateway device 100. For example, when the connection port 108 is a USB port, the first device 500 may be an electronic device having a USB port. As for the first device 500, it has a device code for the gateway device 100 to identify what type of device the first device is. To be more specific, when the gateway device 100 detects the first device 500 has been inserted into the connection port 108 (i.e., the connection port 502 is connected to the connection port 108), it identifies the type to which the first device 500 belongs based on the device code of the first device 500 and generate a notification message including first identification (ID) information of the first device 500 and then sends the notification message to the mobile device 300 via the established connection. In some embodiments, the storage device 106 of the gateway device 100 may also include a list of verified devices, which includes a number of verified devices, their codes, and related information. Additionally, the gateway device 100 may further determine whether or not the device code of the first device 500 is in the list. If so, the type to which the first device 500 belongs can be identified to generate the abovementioned notification message; conversely, if the device code of the first device 500 is not in the list, a request will be sent to the first device 500 to request for performing a verification procedure with the cloud server 200. After successful verification, the first device 500 and its device code will be added to the list of verified devices to generate the above-mentioned notification message and have it uploaded to the cloud server 200, thereby updating the list of verified devices in the cloud server 200. Afterwards, the mobile device 300 can receive the abovementioned notification message containing the first ID information through the cloud server 200.

When the mobile device 300 receives the notification message, in step S306, the mobile device 300 identifies the first device 500 based on the first identification information and displays a user interface (e.g., the user interface 3062 as shown in FIG. 2A), wherein the user interface displays at least one APP corresponding to the first device 500. Because the first device 500 may have a plurality of corresponding APPs, the user interface of the application corresponding to the gateway device 100 displays the APP menu corresponding to the first device 500 (as shown in the display area 3062-3 of FIG. 2A) for selection by the user.

In one embodiment, the first device 500 may include a sensor device (for example: a temperature sensor, a light sensor, a humidity sensor, etc.) and the sensor device may provide sensor data, wherein the mobile device 300 may instruct the first device 500 to provide the sensor data via the gateway device 100 by the corresponding at least one application. For example, when the gateway device 100 detects that a temperature sensor has been plugged into its port (e.g., a USB port) 108, it sends a notification message to the application on the mobile device 300 to notify the mobile device 300 that a device has been inserted. Subsequently, the mobile device 300 identifies that the inserted device is a temperature sensor based on information of the notification message and display a user interface which displays a plurality of APPs of temperature sensor for selecting by the user. Each APP provides the temperature sensor with different functionalities. The users may then select one or more APPs from the APPs according to their usage requirements. For example, the selection may include checking or clicking on a corresponding APP item on the user interface, but the invention is not limited thereto.

After the user completes the APP selection described above, in step S308, the mobile device 300 then obtains a selection of one or more services of the selected at least one application through the user interface. Similarly, as each selected APP may have a plurality of corresponding services, the user interface of the application corresponding to the gateway device 100 displays the service menu corresponding to the first device 500 (as shown in the display area 3062-5 of FIG. 2B) for the user to choose. Each service may cause the first device 500 to have a different operation. The users may then select one or more services from a plurality of services according to their usage requirements. When the mobile device 300 chooses to install the corresponding APP, the APP has built-in a plurality of predefined services in addition to the general application. The user can then use these predefined services to configure the service to be installed to the gateway device 100. Specifically, the mobile device 300 may receive a selection signal indicating a service selected by the user through the user interface and automatically download the selected service for installation from a source 202 according to the selection signal. For example, selection of a service may include checking or clicking on a corresponding service item on the user interface, but the invention is not limited thereto. The source 202 can be an App store, such as the Google PLAY store of the Android system or the Apple App store of the Apple system. In other embodiments, the source 202 can be a cloud storage space or a website storing all the corresponding services of the first device 500 to be configured, and the mobile device 300 may be linked to the cloud storage space or website to obtain the selected service for installation. In another embodiment, the user may also upload the service to the gateway device 100 after writing the service.

In some embodiments, the user interface may further provide a service editing interface (e.g., the service editing interface 3062-7) that allows the user to modify the contents of the predefined services by using the aforementioned predefined service as the template to generate contents of the customized service. The service editing interface may display the source code for a first service of the predefined services, and the user may modify the source code for the first service of the predefined services through the editing function of the service editing interface, such as adjusting or adding the relevant parameters, to generate the required second service. For example, if the default first service represents a source code that controls the first device 500 to flash once every ten seconds, the user can easily modify the time parameter of the flashing in the source code to become flash once every second or flash twice every ten seconds through the editing function of the service edit interface to generate the desired customized second service.

In other embodiments, the service editing interface may also allow the user to customize the contents of the required services by programing a control code online directly using specific programming languages, such as Javascript, C++, live code, and other programming languages, or using specific writing methods (such as dragging predefined functional blocks, etc.) to program the control code related to the service or import programed control code.

After obtaining the one or more services selected by the user, in step S310, the obtained one or more services are transmitted to the gateway device 100 via the established connection by the mobile device 300 to configure the one or more services on the gateway device 100, such that the gateway device 100 automatically performs the one or more services configured thereon. In some embodiments, the one or more services obtained are included in the APP, so that the services included therein are automatically performed (executed) on the gateway device 100 when the APP is installed and executed by the gateway device 100. After the gateway device 100 receives the services uploaded by the mobile device 300, the gateway device 100 automatically installs all the uploaded services on it and automatically performs the installed service to complete the configuration of the first device 500. Thus, the service performed on the gateway device 100 may control the first device 500 to perform a specified operation or action.

When a service has been uploaded to the gateway device 100, the gateway device 100 automatically performs the service. As described above, each service is a program written for the first device 500, and it will be operated continuously as long as the gateway device 100 is activated, so that the operation of the first device 500 can be controlled by the service. For example, when the first device 500 is a camera and the service is set to be an operation of 24-hours of continuous recording, the gateway device 100 will continue to perform recording for 24 hours after the gateway device 100 automatically performs the service. Similarly, when the service is set to be an operation of taking a picture every minute and then making a time-lapse photography and immediately streaming the time-lapse photography to the remote device after photographing, after the gateway device 100 automatically performs the service, the camera starts to take a picture every minute and then make a time-lapse photography and immediately stream the time-lapse photography to the remote device after photographing.

When another first device 500 has been inserted into the gateway device 100, the aforementioned steps S302 to S310 may be repeated so as to set the desired service on the mobile device 300 and then uploaded to the gateway device 100 so that the gateway device 100 automatically performs the service to control the operation of the inserted device.

In some embodiments, when a user wants to add or remove a part of the services of a first device 500 configured on the gateway device 100, the user may further add a new service to the gateway device 100 or remove the part of the services configured on the gateway device 100. For example, the user may modify the configurations directly through the user interface or by linking to the website so as to modify the configured services after the configurations of the services have been completed, but the invention is not limited thereto. In some embodiments, the service may be stored in the cloud space, and the cloud space may contain service settings shared by the users, so that the user may log in to the cloud space to select the desired service therefrom and then upload it to the gateway device 100. It is noted that other users or hardware device developers can upload the services that they can provided to a specified sharing website in advance.

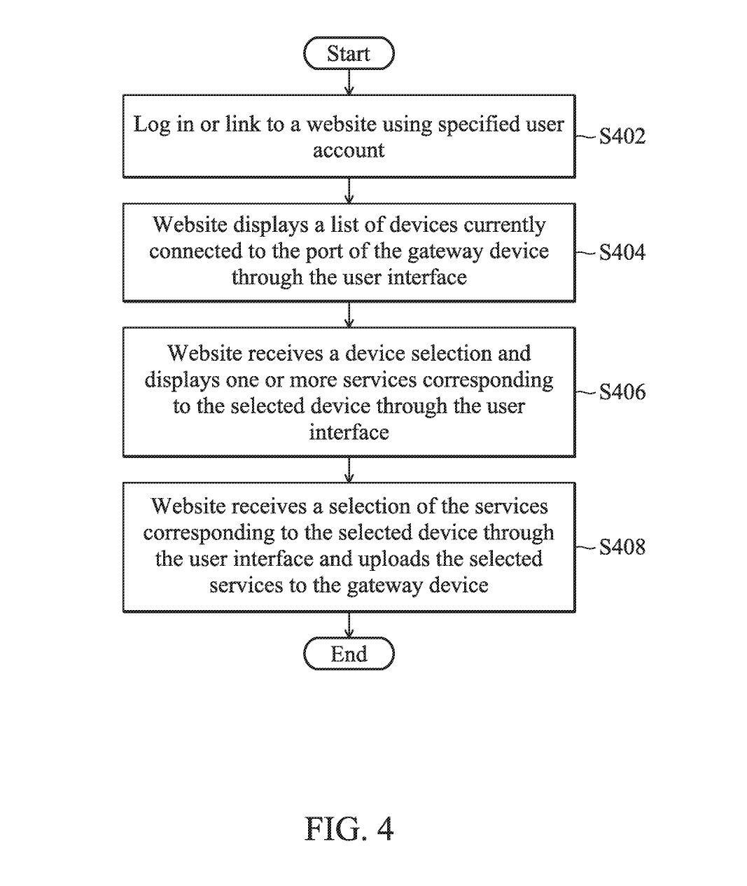

FIG. 4 is a flowchart of another embodiment of a device configuration method for providing device configuration in a communication network of the invention. The device configuration method can be applied to the cloud management system 10 as shown in FIG. 1. For example, the method can be performed by the processor 104 of the gateway device 100, the cloud server 200 and the processor 304 of the mobile device 300 as shown in FIG. 1.

When a first device 500 connects the gateway device 100 via a wired connection (e.g., a USB connection) or a wireless connection (e.g., a BT, Zigbee or other wireless connection), the APP corresponding to the gateway device 100 on the mobile device 300 will receive a notification message. The APP corresponding to the gateway device 100 then requests the user to log in or link to the designated website with a specified user account such as a Facebook or G+ account (step S402). When the login is successful, the website provides a user interface through which the website displays a list of devices currently connected to the port of the gateway device 100 (i.e., the devices that the gateway device 100 has already connected) through the user interface (step S404) for the user to select the device to be configured.

When the user selects one of the devices, the website receives a device selection and displays one or more services corresponding to the selected device for the user selection through the user interface (step S406). The user can then select the service to be uploaded according to the selected device, and the website can receive the selection of the services corresponding to the selected device and upload the selected services to the gateway device 100 through the user interface (step S408). When the selected service is uploaded to the gateway device 100, the gateway device 100 automatically installs and performs the service.

In another embodiment, when the first device 500 has been removed from the gateway device 100, the service corresponding to the first device 500 configured on the gateway device 100 will automatically suspend or stop execution or be automatically removed from the gateway device 100 to save storage space and computing resources.

For explanation, specific device configuration methods are illustrated as actual implementation examples in the following embodiments, and those skilled in the art will understand that the present invention is not limited thereto.

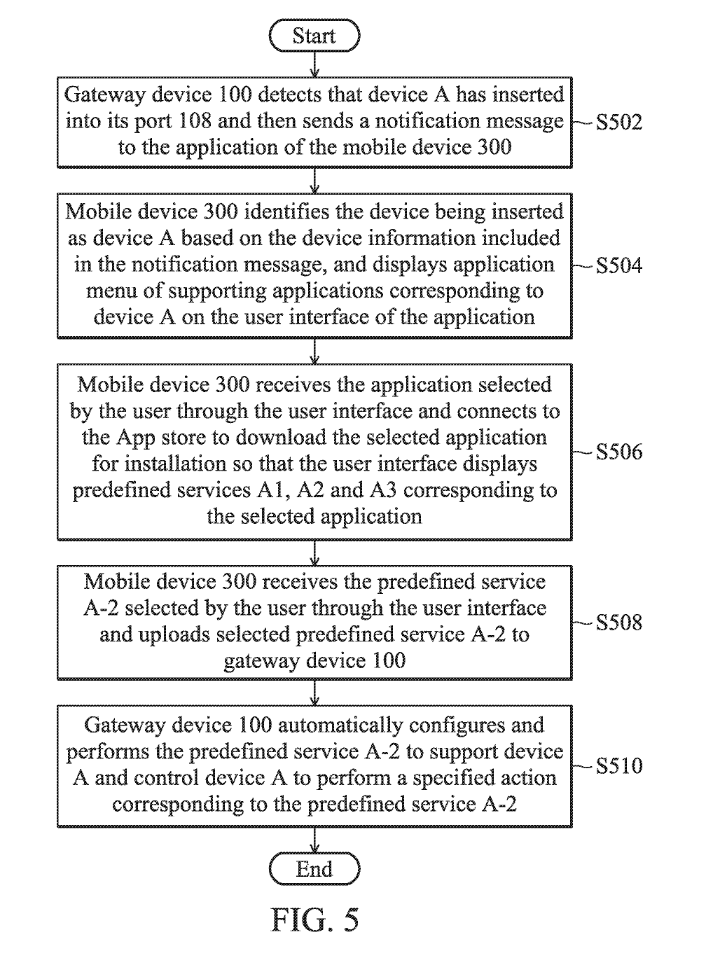

FIG. 5 is a flowchart of an embodiment of a device configuration application of the invention for configuring a gateway device to perform remote controlling on the devices inserted thereto. The device configuration method can be applied to the cloud management system 10 as shown in FIG. 1. Please refer together with FIG. 1, FIG. 2A, FIG. 2B and FIG. 5. In this embodiment, it is assumed that the first device 500 is a device A (for example, a sensor). When the device A is wired or wirelessly connected to the port of the gateway device 100, the gateway device 100 detects that there is a device A inserted into its port 108, and thus sends a notification message about the device A to the application of the mobile device 300 (step S502).

When the application of the mobile device 300 receives the notification message about the device A, the mobile device 300 identifies the device inserted as the device A based on the device information included in the notification message, and links to the source 202 (for example, the Apple App store) and obtains the application menu of supporting applications corresponding to the device A and displays the application menu on the user interface of the application for selection by the user, as shown in FIG. 2A (step S504).

The user may select one of the applications in the application menu for installation through the user interface 3062 as shown in FIG. 2A, wherein the installed application also includes a predefined service A-1, a predefined service A-2 and a predefined service A-3 corresponding to the device A. The mobile device 300 receives the application selected by the user through the user interface and connects to the Apple App store to download the selected application for installation so that the user interface displays the predefined services A1, A2 and A3 corresponding to the selected application, as shown in FIG. 2B (step S506). Similarly, the user may select the predefined service A-2 from the user interface 3062 of FIG. 2B, and the application of the mobile device 300 receives the predefined service A-2 selected by the user through the user interface and uploads the selected predefined service A-2 to the gateway device 100 (step S508). After the gateway device 100 receives the predefined service A-2 uploaded by the mobile device 300, the gateway device 100 can automatically configure and perform the predefined service A-2 to support the device A and control the device A to perform a specified action corresponding to the predefined service A-2 (step S510).

Similarly, when another device B is wired or wirelessly connected to the port of the gateway device 100, the application of the mobile device 300 receives a notification message about the device B and links to the source 202 and obtains the application menu of supporting applications corresponding to the device B and displays the application menu on the user interface of the application for selection by the user. The user may select one of the applications in the application menu for installation, wherein the installed application also includes a predefined service B-1, a predefined service B-2 and a predefined service B-3 corresponding to the device B. The user may then select the predefined service B-3 from the predefined services of the installed application, and the application of the mobile device 300 will upload the selected predefined service B-3 to the gateway device 100. After the gateway device 100 receives the uploaded predefined service B-3, it can automatically configure and perform the predefined service B-3 to support the device B and control the device B to perform a specified action corresponding to the predefined service B-3.

Thereafter, after the gateway device 100 detects that the device B has been removed without being connected to the port of the gateway device 100, the gateway device 100 can automatically stop or suspend the operation of the predefined service B-3, or it can remove the predefined service B-3 directly. Accordingly, the storage space and the operation resources of the gateway device 100 can be saved.

Therefore, the cloud management systems and related device configuration methods of the invention can allow gateway devices and mobile devices on the cloud to perform data transmission and can automatically send a message containing information related to an inserted device to a mobile device as notification to activate/launch a corresponding application on the mobile device and drive the gateway device to install required services by the third party when one external device is inserted to the connection port of the gateway device, so that the user can freely determine the functionalities of the gateway device according to the different hardware devices, to improve the scalability of the gateway device in a more intelligent and convenient manner and to easily update the gateway device for supporting a variety of new external devices, thereby collecting data at the remote end through the external device for monitoring and/or remote controlling the external device, thus providing more diversified IoT applications.

Systems and method thereof, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A device configuration method for use in a cloud system including a gateway device, a mobile device and a cloud server, the method comprising:
establishing a connection between the mobile device and the gateway device through the cloud server;
sending, by the gateway device, a notification message to the mobile device through the established connection when detecting that a first device is connected to a connection port, wherein the notification message includes first identification information corresponding to the first device;
identifying, by the mobile device, the first device according to first identification information within the notification message and displaying a user interface, wherein the user interface displays at least one application corresponding to the first device in response to receiving the notification message;
obtaining, by the mobile device, one or more services corresponding to the at least one application via the user interface; and
transmitting, by the mobile device, the obtained one or more services to the gateway device through the established connection to configure the one or more services on the gateway device such that the gateway device automatically performs the one or more services, thereby controlling the operation of the first device.

2. The device configuration method of claim 1, further comprising:
connecting, by the mobile device, to a source to obtain the at least one application and a plurality of predefined services corresponding to the at least one application from the source to be displayed on the user interface,
wherein the one or more services corresponding to the at least one application is selected from at least one of the predefined services.

3. The device configuration method of claim 2, wherein the user interface further provides a service editing interface, and the one or more services corresponding to the at least one application includes a customized service generated by editing or modifying at least one of the predefined services by the service editing interface.

4. The device configuration method of claim 2, wherein the user interface further provides a service editing interface, and the one or more services corresponding to the at least one application is a customized service generated by directly writing by the service editing interface.

5. The device configuration method of claim 2, wherein the source is a website or a cloud storage space.

6. The device configuration method of claim 2, wherein the source is an application (APP) store.

7. The device configuration method of claim 1, further comprising:
automatically stopping or pausing, by the gateway device, the operations of the configured one or more services of the first device, or automatically removing the configured one or more services of the first device when detecting that the first device has been removed.

8. The device configuration method of claim 1, wherein the first device is wirelessly connected to the connection port of the gateway device.

9. A cloud management system, comprising:
at least one first device having a connection port;
a gateway device having a connection port;
a mobile device; and
a cloud server coupled to the gateway device and the mobile device via a communication network,
wherein the mobile device and the gateway device establishes a connection through the cloud server, and the gateway device sends a notification message to the mobile device through the established connection when detecting that the connection port is connected to the connection port of the first device such that the mobile device, in response to receiving the notification message, identifies the first device according to the notification message and displays a user interface which displays at least one application corresponding to the first device, obtains one or more services corresponding to the at least one application via the user interface, and transmits the obtained one or more services to the gateway device through the established connection to configure the one or more services on the gateway device such that the gateway device automatically performs the one or more services, thereby controlling the operation of the first device.

10. The cloud management system of claim 9, further comprising a source, wherein the mobile device further connects to the source to obtain the at least one application and a plurality of predefined services corresponding to the at least one application from the source to be displayed on the user interface, wherein the one or more services corresponding to the at least one application is selected from at least one of the predefined services.

11. The cloud management system of claim 10, wherein the user interface further provides a service editing interface, and the one or more services corresponding to the at least one application includes a customized service generated by editing or modifying at least one of the predefined services by the service editing interface.

12. The cloud management system of claim 9, wherein the connection port of the gateway device is a universal serial bus (USB) port.

13. The cloud management system of claim 11, wherein the connection port of the gateway device is a wireless connection port and the first device is wirelessly connected to the connection port of the gateway device.

14. The cloud management system of claim 9, wherein the first device is a sensor device.

15. The cloud management system of claim 9, wherein the gateway device is a small-scale computing means having the ability to operate independently to operate a specific operating system.

16. The cloud management system of claim 9, wherein the mobile device system is a handheld device or a portable device.
